(19) United States
(12) Patent Application Publication
(10) Pub. No.: US 2017/0105386 A1
(43) Pub. Date: Apr. 20, 2017

(54) PET FEEDER TABLE

(71) Applicant: Ying Wu, Diamond Bar, CA (US)

(72) Inventor: Ying Wu, Diamond Bar, CA (US)

(21) Appl. No.: 14/918,044

(22) Filed: Oct. 20, 2015

(51) Int. Cl. A01K 5/01

(52) U.S. Cl. CPC A01K 5/0114

(57) ABSTRACT

Disclosed is the pet feeder table for feeding pets in one or more bowls and in at least one of the ingredient container separately. The pet feeder table includes a top frame, a first sidewall, a second sidewall, a first bottom frame and a third sidewall. The top frame is having one or more bowl openings for receiving one or more bowls. The top frame is further having a left edge and a right edge and is inclined towards the surface. The first sidewall and the second sidewall are extending downwards from the left edge and the right edge respectively of the top frame. Further, the first sidewall is having a first front edge and a first rear edge greater in height than the first front edge. The second sidewall is having a second front edge and a second rear edge greater in height than the second front edge. The first bottom frame is placed on the surface configured for receiving the ingredient container and is adjacently extending outwards from the first sidewall. Further, the first bottom frame is having a first bottom edge. The third sidewall is having a third front edge and third rear edge greater in height than the third front edge. Further, the third sidewall is extending upwards from the first bottom edge for providing housing to the ingredient container.

### BACKGROUND OF THE INVENTION

1. Field of the Invention

The present invention generally relates to a pet feeder table and more particularly relates to a pet feeder table that incorporates receiving of different types of food in different containers.

2. Description of Related Art

It has been found that the health of a dog, cat, or other such pet can be improved by providing a feeding position which is raised above the ground or floor. This reduces or eliminates the need for the pet to position its head downward during feeding. Among the benefits of an elevated feeding position are that the pet swallows less air during the feeding.

While there are structures known in the prior art which provide an elevated position for a feeding vessel, these structures have many significant disadvantages. The disadvantages include feeding vessels which are fixed to the support structure or to the floor, and further have flat platforms.

Further, it becomes messy if the table has place for only two bowl containers. Therefore, there is a need of a pet feeder table that has a tilted platform for easy eating and licking. Furthermore, the pet feeder table provides place for a container that allows growing of natural grass to be eaten by the pets at comfortable height.

### SUMMARY OF THE INVENTION

In accordance with the teachings of the present invention, a pet feeder table for feeding pet in one or more bowls and in at least one ingredient container separately is provided.

An object of the present invention is to provide a pet feeder table placed on a surface for feeding pet in one or more bowls and in at least one ingredient container separately. The pet feeder table includes a top frame, a first sidewall, a second sidewall, a first bottom frame and a third sidewall. The top frame is having one or more bowl openings for receiving one or more bowls. The top frame is further having a left edge and a right edge and is inclined towards the surface.

The first sidewall and the second sidewall are extending downwards from the left edge and the right edge respectively of the top frame. Further, the first sidewall is having a first front edge and a first rear edge greater in height than the first front edge. The second sidewall is having a second front edge and a second rear edge greater in height than the second front edge.

The first bottom frame is placed on the surface configured for receiving the ingredient container and is adjacently extending outwards from the first sidewall. Further, the first bottom frame is having a first bottom edge. The third sidewall is having a third front edge and third rear edge greater in height than the third front edge. Further, the third sidewall is extending upwards from the first bottom edge for providing housing to the ingredient container.

Another object of the present invention is to provide the pet feeder table including a second bottom frame having a second bottom edge and a fourth sidewall extending from the second bottom edge. The second bottom frame is placed on the surface for receiving the ingredient container and is adjacently extending outwards from the second sidewall. The fourth sidewall housing the ingredient container is having a fourth front edge and a fourth rear edge greater in height than the fourth front edge.

Another object of the present invention is to provide one or more pet bowls to be placed in at least one of the one or more bowl openings in the top frame. Further, the pet feeder table includes pet food container configured on top of at least one of the first bottom frame and the second bottom frame. The pet food container allows growing of solid free grass.

Another object of the present invention is to provide pet food container wherein the top frame is inclined fifteen degrees towards the surface. Further, the one or more pet bowls are microwave safe. Further, the pet feeder table is made of wood.

Features and advantages of the present invention, as well as the structure and operation of various embodiments of the present invention are described in detail below with reference to the accompanying drawings.

### BRIEF DESCRIPTION OF DRAWINGS

FIG. 1 illustrates a perspective view of the pet feeder table in accordance with a preferred embodiment of the present invention;

FIG. 2 illustrates another perspective view of the pet feeder table in accordance with another preferred embodiment of the present invention;

FIG. 3 illustrates another perspective view of a pet feeder table in accordance with another preferred embodiment of the present invention; and

FIG. 4 illustrates another perspective view of a pet feeder table in accordance with a preferred embodiment of the present invention.

### DETAILED DESCRIPTION OF DRAWINGS

While this technology is illustrated and described in a preferred embodiment, a pet feeder table may be produced in many different configurations, forms, and materials. There is depicted in the drawings and will herein be described in detail, as a preferred embodiment of the invention, with the understanding that the present disclosure is to be considered as an exemplification of the principles of the invention, the associated functional specifications for its construction and is not intended to limit the invention to the embodiment illustrated. Those skilled in the art, will envision many other possible variations within the scope of the technology described herein.

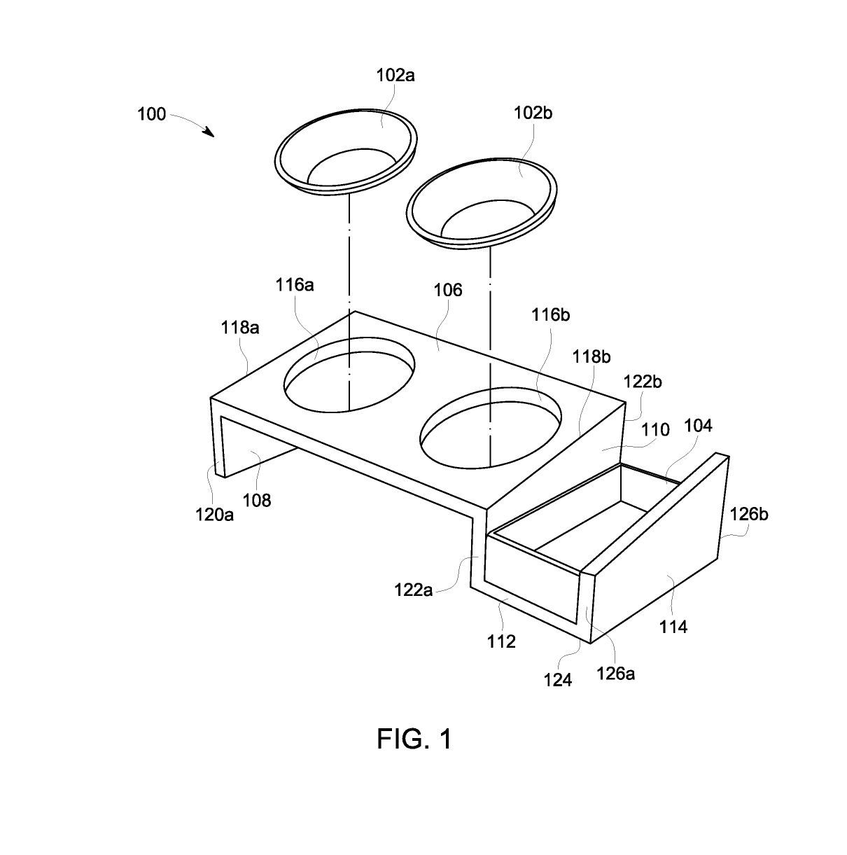

FIG. 1 illustrates a perspective view of the pet feeder table 100 in accordance with a preferred embodiment of the present invention. The pet feeder table 100 is placed on a surface for feeding pet in one or more bowls such as 102a and 102b and in at least one ingredient container 104 separately. The pet feeder table 100 includes a top frame 106, a first sidewall 108, a second sidewall 110, a first bottom frame 112 and a third sidewall 114.

The top frame 106 is having one or more bowl openings such as 116a and 116b for receiving bowls 102a and 102b respectively. The top frame 106 is having a left edge 118a and a right edge 118b. The top frame 106 is inclined towards the surface. In a preferred embodiment of the present invention, the top frame 106 is inclined at an angle of 15 degrees with the surface.

In a preferred embodiment of the present invention, the one or more bowl openings such as 116a and 116b are circular. However, it would be readily apparent to those skilled in the art that various shapes of the bowl openings 116a and 116b may be envisioned without deviating from the scope of the present invention.

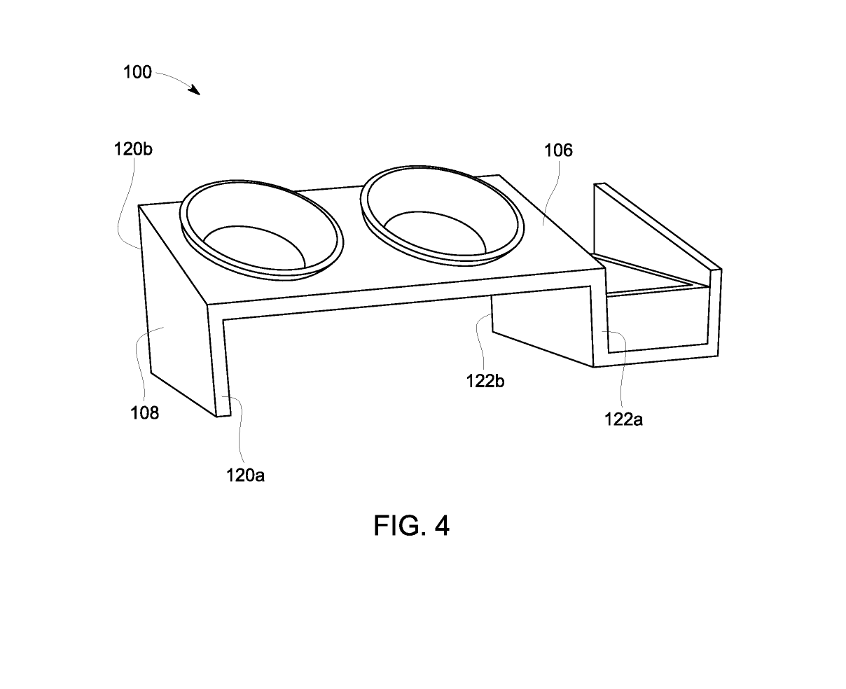

The first sidewall 108 is extending downwards from the left edge 118a of the top frame 106. The first sidewall 108 is having a first front edge 120a and a first rear edge (not shown in FIG. 1). The first rear edge (not shown in FIG. 1) is greater in height than the first front edge 120a. The first rear edge (not shown in FIG. 1) is shown and explained in conjunction with FIG. 4 of the present invention.

The second sidewall 110 is extending downwards from the right edge 118b of the top frame 106. The second sidewall 110 is having a second front edge 122a and a second rear edge 122b. The second rear edge 122b is greater in height than the second front edge 122a. In a preferred embodiment of the invention, the difference in the height of second front edge 122a and the second rear edge 122b; and the first front edge 120a and the first rear edge (not shown in FIG. 1) results in inclining the top frame 106.

The first bottom frame 112 is placed on the surface configured for receiving the ingredient container 104. The first bottom frame 112 is adjacently extending outwards from the second sidewall 110. The first bottom frame 112 is having a first bottom edge 124. The third sidewall 114 is extending upwards from the first bottom edge 124 of the first bottom frame 112 for providing housing to the ingredient container 104.

The ingredient container 104 may be used to serve water to the pets. However, it would be readily apparent to those skilled in the art that the ingredient container 104 may be used to serve any type of food to the pet without deviating from the scope of the present invention.

In another preferred embodiment of the present invention, the third sidewall 114 includes a third front edge 126a and a third rear edge 126b greater than the height of the third front edge 126a. The height of the third rear edge 126b is similar to the height of the second rear edge 122b and first rear edge (not shown in FIG. 1) and the height of third front edge 126a is similar to the height of the second front edge 122a and the first front edge 120a.

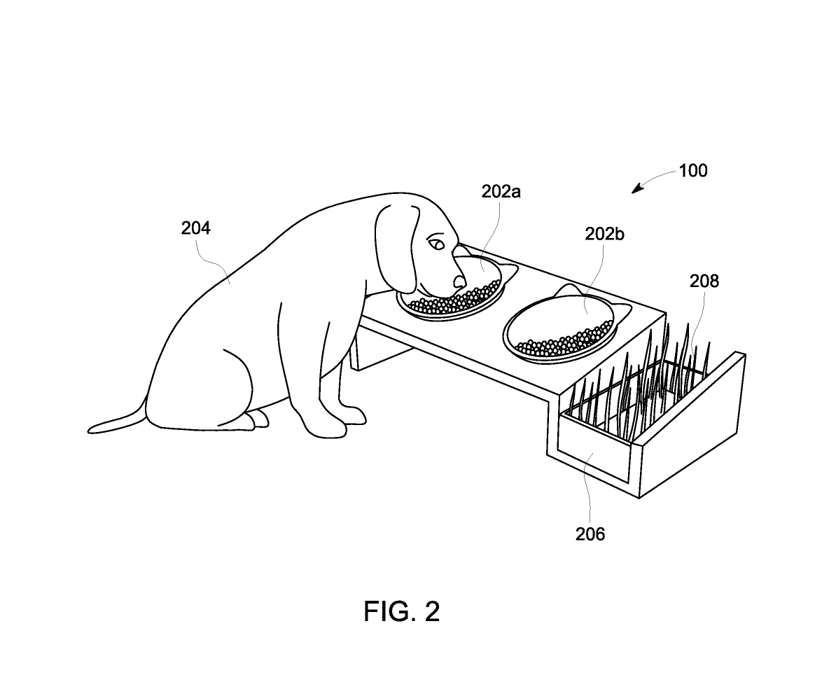

FIG. 2 illustrates another perspective view of the pet feeder table 100 in accordance with another preferred embodiment of the present invention. The pet feeder table 100 further includes one or more pet bowls such as 202a and 202b for receiving food and water. In a preferred embodiment of the present invention, the one or more pet bowls 202a and 202b are cat-shaped.

The pet bowl 202a may be used to give solid food and the pet bowl 202b may be used to serve water for a single pet such as dog 204. However, for multiple pets (not shown in FIG. 2), both the pet bowls 202a and 202b may have solid food to serve them separately. The pet bowls 202a and 202b are microwave and dishwasher safe. It would be readily apparent to those skilled in the art that various pet may be envisioned such as cat, mouse, mice etc without deviating from the scope of the present invention.

In another preferred embodiment of the present invention, the pet feeder table 100 further includes a pet food container 206 for serving solid free grass 208 along with the food ingredients in the one or more bowls such as 202a and 202b. However, it would be readily apparent to those skilled in the art that the pet food container 206 may be used for other purposes without deviating from the scope of the present invention.

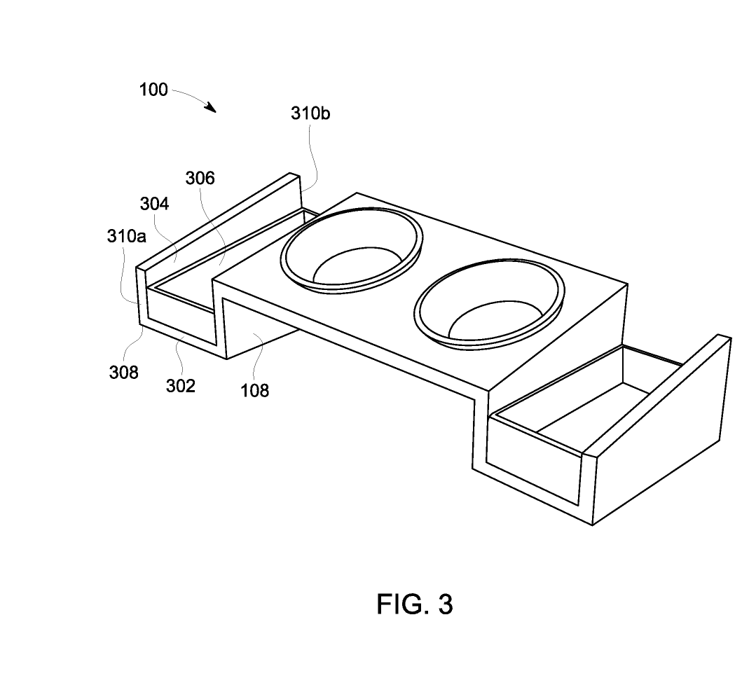

FIG. 3 illustrates another perspective view of a pet feeder table 100 in accordance with another preferred embodiment of the present invention. The pet feeder table 100 further includes a second bottom frame 302 and a fourth sidewall 304. The second bottom frame 302 is placed on the surface configured for receiving the ingredient container 306. Further, the second bottom frame 302 is having a second bottom edge 308 and is further adjacently extending outwards from the first sidewall 108.

The fourth sidewall 304 is extending upwards from the second bottom edge 308 of the second bottom frame 302. The fourth sidewall 304 is having a fourth front edge 310a and a fourth rear edge 310b is greater in height than the fourth front edge 310a. The ingredient container 306 may be used to feed water along with food ingredient separately to the pet.

FIG. 4 illustrates another perspective view of a pet feeder table 100 in accordance with a preferred embodiment of the present invention. The first sidewall 108 is having a first front edge 120a and a first rear edge 120b. The first rear edge 120b is greater in height than the first front edge 120a. The height of the first rear edge 120b is similar to the height of the second rear edge 122b, and the height of the first front edge 120a is similar to the height of the second front edge 122a to maintain the inclination of the top frame 106 against the surface.

The present invention offer various advantages such as the height of the front edges is built in a way to limit the pet from waking under or knocking over the feeder. The top frame is inclined for easy eating and licking. Further, the raised stand design lowers stress and pressure to the pet's joints and stomach. The pet bowls are wide enough to reduce whisker stress for the cat, enhancing their comfort while eating. Further, the pet bowls are heat and the dishwasher safe. The top frame is ⅗ inch in thickness and is coated with water and scratch Resistant Paint. Further, the wooden top frame absorbs saliva and moisture.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments where chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. A pet feeder table placed on a surface for feeding pet in one or more bowls and in at least one ingredient container separately, the pet feeder table comprising:
a top frame having one or more bowl openings for receiving one or more bowls, wherein the top frame having a left edge and a right edge, further the top frame inclined towards the surface;
a first sidewall extending downwards from the left edge of the top frame, wherein the first sidewall having a first front edge; and a first rear edge greater in height than the first front edge;
a second sidewall extending downwards from the right edge of the top surface, wherein the second sidewall having a second front edge and a second rear edge greater in height than the second front edge;
a first bottom frame placed on the surface configured for receiving the ingredient container and further the first bottom frame adjacently extending outwards from the second sidewall, further wherein the first bottom frame having a first bottom edge; and
a third sidewall extending upwards from the first bottom edge of the first bottom frame for providing housing to the ingredient container.

2. The pet feeder table according to claim 1, wherein the third sidewall having a third front edge and a third rear edge greater in height than the third front edge.

3. The pet feeder table according to claim 1 further comprising one or more pet bowls, wherein at least one of the one or more pet bowls to be placed in at least one of the one or more bowl openings in the top frame.

4. The pet feeder table according to claim 1 further comprising a pet food container configured on top of at least one of the first bottom frame; and the second bottom frame.

5. The pet feeder table according to claim 4, wherein the pet food container is configured for serving solid free grass along with the food ingredients in the one or more bowls.

6. The pet feeder table according to claim 1, wherein the top frame is inclined fifteen degrees towards the surface.

7. The pet feeder table according to claim 1, wherein the one or more pet bowls is microwave safe.

8. The pet feeder table according to claim 1, wherein the top frame, the first sidewall, the second sidewall, the first bottom frame, the second bottom frame, the third sidewall and the fourth sidewall are formed of wood.

9. The pet feeder table according to claim 1 further comprising:
a second bottom frame placed on the surface configured for receiving the ingredient container and further the second bottom frame adjacently extending outwards from the first sidewall, further wherein the second bottom frame having a second bottom edge; and
a fourth sidewall extending upwards from the second bottom edge of the second bottom frame, wherein the fourth sidewall having a fourth front edge and a fourth rear edge greater in height than the fourth front edge.
